(19) United States
(12) Patent Application Publication
(10) Pub. No.: US 2010/0166470 A1
(43) Pub. Date: Jul. 1, 2010

(54) IMAGE FORMING APPARATUS AND FIXING DEVICE

(75) Inventor: Shuji YOKOYAMA, Shizuoka-ken (JP)

Correspondence Address: PATTERSON & SHERIDAN, L.L.P., 3040 POST OAK BOULEVARD, SUITE 1500, HOUSTON, TX, 77056, US

(73) Assignees: KABUSHIKI KAISHA TOSHIBA, Tokyo (JP); TOSHIBA TEC KABUSHIKI KAISHA, Tokyo (JP)

(21) Appl. No.: 12/622,017

(22) Filed: Nov. 19, 2009

Related U.S. Application Data
(60) Provisional application No. 61/142,074, filed on Dec. 31, 2008.

(30) Foreign Application Priority Data
Aug. 17, 2009 (JP) 2009-188611

(51) Int. Cl. G03G 15/20

(52) U.S. Cl. 399/330

(57) ABSTRACT

According to one embodiment, an image forming apparatus includes an image forming portion to form an image on a sheet, a heating rotation portion to heat the sheet to fix the image on the sheet, and a coil to provide magnetic flux to the heating rotation portion, one end of the coil is closer to the heating rotation portion than another end of the coil in a direction of an axis of rotation of the heating rotation portion.

### CROSS-REFERENCE TO RELATED APPLICATION

This application is based upon and claims the benefit of priority from U.S. provisional application 61/142,074, filed on Dec. 31, 2008, the entire contents of all of which are incorporated herein by reference.

This application is also based upon and claims the benefit of priority from Japanese Patent Application No. 2009-188611, filed on Aug. 17, 2009, the entire contents of all of which are incorporated herein by reference.

### TECHNICAL FIELD

Exemplary embodiments described herein relates to a fixing device of an induction heating system and an image forming apparatus provided with a fixing device of an induction heating system.

### BACKGROUND

Japanese Patent Application Publication No. 2001-235963 discloses a fixing device provided with a plurality of coils facing a heat roller along an axis of the heat roller. The gaps between the coils at the both end portions of the fixing device and the heat roller are smaller than the gap between the coil at the center portion and the heat roller. In the fixing device, that the temperature at the both end portions of the heat roller falls extremely can be avoided, and that the temperature at the portion of the heat roller not contacting the recording paper rises extremely can be prevented.

The fixing device of the Japanese Patent Application Publication No. 2001-235963 does not pay attention to the temperature difference between the both end portions of the heat roller. In the recent image forming apparatus, one end of the heat roller faces the front side of the image forming apparatus, and another end faces the rear side of the image forming apparatus. As a circuit board and a motor generate heat in the inner space at the rear side of the image forming apparatus, the another end of the heat roller is apt to become hotter in temperature than the one end of the heat roller.

In addition, as to the heat roller with one end facing the left side of the image forming apparatus and another end facing the right side of the image forming apparatus, owing to the bilateral symmetrical property of the construction of the image forming apparatus, the temperatures at the both ends of the heat roller are apt to become different.

### SUMMARY

An aspect of the present disclosure relates to an image forming apparatus, containing: an image forming portion to form an image on a sheet; a heating rotation portion to heat the sheet to fix the image on the sheet; and a coil to provide magnetic flux to the heating rotation portion, one end of the coil is closer to the heating rotation portion than another end of the coil in a direction of an axis of rotation of the heating rotation portion.

Another aspect of the present disclosure relates to a fixing device, containing: a heating rotation portion to heat a sheet to fix an image on the sheet; and a coil to provide magnetic flux to the heating rotation portion, one end of the coil is closer to the heating rotation portion than another end of the coil in a direction of an axis of rotation of the heating rotation portion.

### DESCRIPTION OF THE DRAWINGS

FIG. 1 is a perspective view showing an image forming apparatus;

FIG. 2 is a sectional view of a fixing device;

FIGS. 3A˜3G are schematic views showing the relation among an induction coil, a heat roller and a sheet;

FIG. 4 is a perspective view showing a heat roller and an induction coil;

FIGS. 5A˜5G are schematic views showing a modification of an induction coil;

FIG. 6 is a perspective view showing a modification of a heat roller and an induction coil;

FIG. 7 is a sectional view showing a first modification of a fixing device;

FIG. 8 is a sectional view showing a second modification of a fixing device;

FIG. 9 is a perspective view showing another modification of a heat roller and an induction coil.

### DETAILED DESCRIPTION

Hereinafter, an embodiment will be described with reference to the drawings. In addition, in advance of the description, a narrow side of a sheet of A4 size and a narrow side of A3 size are defined as width directions of the sheets, respectively, and long sides of the sheets are defined as length directions of the sheets, respectively.

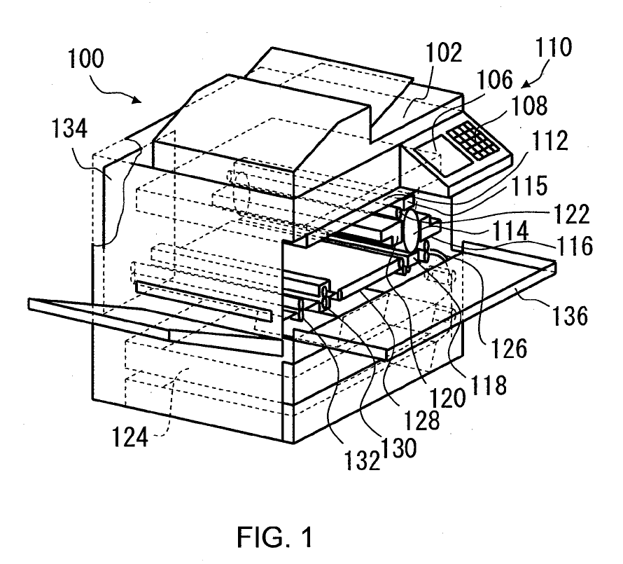

FIG. 1 is a perspective view of an image forming apparatus. An image forming apparatus 100 is provided with an image reader 102 to read in an image which is an object to be read in and an image forming portion to form an image. In addition, at the upper portion of the image forming apparatus 100, an operation panel 110 having a display 106 of a touch panel type and a various type operation key 108 is provided. The operation panel 110 is located at the side face of the image forming apparatus 100, namely at a front side that is a near side in the plane of paper. The back side of the image forming apparatus 100 in the plane of paper is a rear side. The right side of the image forming apparatus 100 in the plane of paper is a right side. The left side of the image forming apparatus 100 in the plane of paper is a left side.

The operation key 108 of the operation panel 110 has a numeric keypad, a reset key, a stop key, a start key and so on, for example. In the display 106, various handlings are inputted such as the sheet size, the number of copies, printing density setting and pullout handling and so on.

The image forming portion is provided with a laser unit 112, a photo conductor 114, a charger 115, a developing device 116, a transfer device 118, a cleaner 120 and a neutralization device 122. The image forming apparatus 100 is further provided with a sheet supply device 124, a sheet conveying path 126, a sheet conveying belt 128, a fixing device 130, an ejection roller 132, a circuit board 134 and a maintenance door 136.

The charger 115 charges the outer circumference surface of the rotating photo conductor 114. The laser unit 112 forms an electrostatic latent image on the charged outer circumference surface of the photo conductor 114. The developing device 116 develops the electrostatic latent image into a toner image with the toner. The transfer device 118 transfers the toner image on the sheet conveyed from the sheet supply device 124 through the sheet conveying path 126. The cleaner 120 cleans away the toner which remains at the photo conductor 114 without being transferred. The neutralization device 122 neutralizes the outer circumference surface of the photo conductor 114.

The sheet conveying belt 128 conveys the sheet on which the toner image was transferred to the fixing device 130. The fixing device 130 fixes the toner image on the sheet. The ejection roller 132 ejects the sheet on which the toner image was fixed from the image forming apparatus 100.

The image forming apparatus 100 is provided with the maintenance door 136 at the front side so as to open up the circuit board 134 which electrically controls the image forming portion including the electric supply to the fixing device 130 toward the rear side and to open up the fixing device 130 toward the front side. The circuit board 134 faces the rear side end surface of the fixing device 130 in the length direction. The circuit board 134 generates heat and make the rear side of the image forming apparatus 100 at a high temperature by blocking the air flow. The space inside the maintenance door 136 is made at a low temperature by ventilating the front side of the image forming apparatus 100. The rear side of the image forming apparatus 100 is made at a higher temperature than the front side.

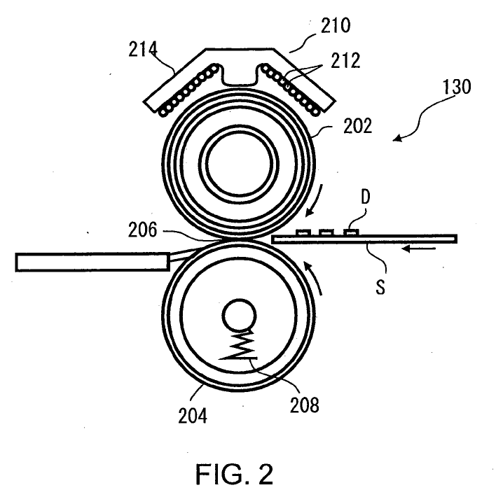

FIG. 2 is a sectional view of the fixing device 130. The fixing device 130 is provided with a heat roller 202 and a pressure roller 204. The heat roller 202 makes contact with the pressure roller 204 to form a nip 206. The diameters of the heat roller 202 and the pressure roller 204 are respectively 40 mm, for example.

The heat roller 202 makes contact with and heats the surface of the sheet S on which the toner image D was transferred. The heat roller 202 rotates in the direction of an arrow in the drawing. The heat roller 202 is provided with a cored bar, a foamed rubber layer, a metal conductive layer, a solid rubber layer and a mold release layer in order from the inside. For example, the formed rubber layer is 5 mm, the metal conductive layer is 40 μm, the solid rubber layer is 200 μm, and the mold release layer is 30 μm thick, respectively. The metal conductive layer is formed by nickel, stainless, aluminum, or a combined material of stainless and aluminum, for example. The rear side of the axis of rotation of the heat roller 202 faces the circuit board 134.

The pressure roller 204 makes contact with the opposite surface of the sheet S. A pressing structure 208 presses the pressure roller 204 toward the heat roller 202. The pressure roller 204 is driven rotated by the heat roller 202. The heat roller 202 and the pressure roller 204 rotate while nipping the sheet S on which the toner image D was formed so as to fix the toner image D on the sheet S. The pressure roller 204 is provided with a cored bar, a rubber layer and a mold release layer in order from the inside. For example, the rubber layer is 1 mm and the mold release layer is 30 thick, respectively.

An induction coil 210 faces the heat roller 202 via a space. The induction coil 210 is provided with litz wires 212 and a magnetic core 214. The magnetic core 214 is of a bent shape so as to enclose the outer circumference of the heat roller 202, for example. The litz wires are a plurality of conductive wires bound up while insulated from each other by the heat resistant polyamide-imide and so on. The litz wires are wound up around the magnetic core 214.

The induction coil 210 generates magnetic flux when the high frequency current is applied. The magnetic flux generates an eddy current in the heat roller 202. The eddy current and the electric resistance of the heat roller 202 generate Joule heat to heat the heat roller 202.

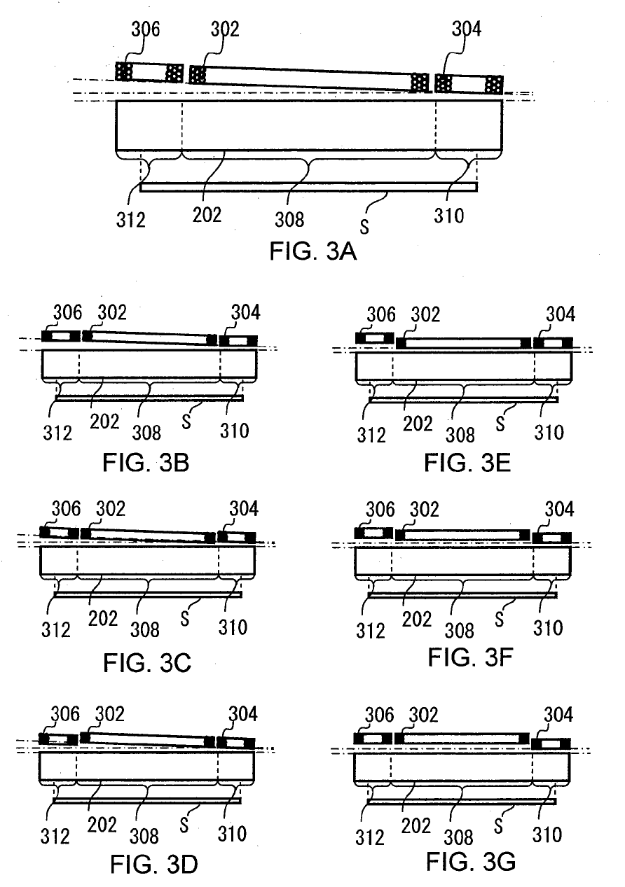

FIGS. 3A to 3G are views showing the relation between the heat roller 202 and a full-sized sheet S. The heat roller 202 has an effective length contacting the sheet S in the direction of the axis of rotation which is equal to or larger than at least a width of the full-sized sheet. The full size is a size of a maximum sheet determined by the specification of the image forming apparatus 100, for example. The full size is the A3 size determined in the JIS, for example. A width of the full-sized sheet is a length of the narrow side of the A3 size of JIS. The pressure roller 204 may have an effective length contacting the sheet S in the direction of the axis of rotation which is equal to or larger than at least a width of the full-sized sheet.

The induction coil 210 includes a center coil 302, a front side coil 304 and a rear side coil 306. The front side coil 304, the center coil 302 and the rear side coil 306 are arranged in this order from the front side in the direction of the axis of rotation of the heat roller 202. The center coil 302 supplies the magnetic flux to a center area 308 in the direction of the axis of rotation of the heat roller 202. The center area 308 does not face both the end edges of the full-sized sheet S. The front side coil 304 supplies the magnetic flux to a front side area 310 in the direction of the axis of rotation of the heat roller 202. The front side area 310 faces the front side end edge of the full-sized sheet S. The rear side coil 306 supplies the magnetic flux to a rear side area 312 in the direction of the axis of rotation of the heat roller 202. The rear side area 312 faces the rear side end edge of the full-sized sheet S.

FIGS. 3A to 3G show further the distances between the induction coil 210 and the heat roller 202. As the rear side coil 306 is more distant from the heat roller 202 than the front side coil 304 is, the rear side coil 306 supplies the less magnetic flux to the heat roller 202 than the front side coil 304. As the supplied magnetic flux is smaller, the heat roller 202 is unlikely to generate heat at the rear side area 312 than the front side area 310. That the heat roller 202 is unlikely to generate heat at the rear side area 312 than the front side area 310 negates the temperature difference between both the end portions of the heat roller 202 caused by the temperature difference in the space between the rear side of the image forming apparatus 100 which is at the high temperature and the front side of the image forming apparatus 100 which is at the low temperature.

As shown in FIG. 3A, the front side coil 304, the center coil 302 and the rear side coil 306 may be arranged lineally distant from the heat roller 202 in this order. As shown in FIG. 3B, while the front side coil 304, the center coil 302 and the rear side coil 306 are distant from the heat roller 202 in this order, the front side coil 304 and the rear side coil 306 may be arranged in parallel with the heat roller 202 and the center coil 302 may be inclined to the heat roller 202. As shown in FIG. 3C and FIG. 3D, while the rear side coil 306 is arranged more distant from the heat roller 202 than the front side coil 304 is, the front side coil 304, the rear side coil 306 and the center coil 302 may be inclined to the heat roller 202. As shown in FIG. 3E, FIG. 3F and FIG. 3G, while the rear side coil 306 is arranged more distant from the heat roller 202 than the front side coil 304 is, the front side coil 304, the rear side coil 306 and the center coil 302 may be arranged in parallel with the heat roller 202.

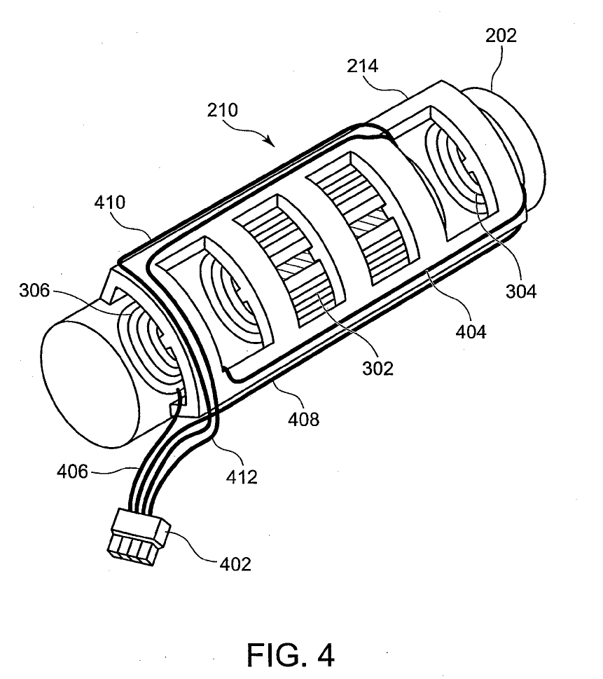

FIG. 4 is a perspective view of the heat roller 202 and the induction coil 210. The front side coil 304 is connected in series with the rear side coil 304 through an electric wire 404. The rear side coil 306 has an electric wire 406. The front side coil 304 has an electric wire 408. The electric wire 406 and the electric wire 408 are held together at the rear side. The front side coil 304 and the rear side coil 306 are connected in series from the electric wire 406 to the electric wire 408. The center coil 302 has an electric wire 410 and an electric wire 412. Both the electric wire 410 and the electric wire 412 are held together at the rear side. As for the center coil 302, the electric wire 410, the center coil 302 and the electric wire 412 are connected in series.

The electric wire 406, the electric wire 408, the electric wire 410 and the electric wire 412 are held together in a connector 402. The connector 402 is connected to the circuit board 134 locating at the rear side of the image forming apparatus 100.

As the length of the electric wire from the connector 402 to the front side coil 304 is longer than the length of the electric wire from the connector 402 to the rear side coil 306, the resistance of the electric circuit from the connector 402 to the front side coil is larger than that from the connector 402 to the rear side coil 306. Because of the difference between the resistances of the electric circuits, as the current flows more through the rear side coil 306 than through the front side coil 304, the rear side coil 306 provides more magnetic flux to the heat roller 202 than the front side coil 304. That the rear side coil 306 is more distant from the heat roller 202 than front side coil 304 is, can correct the difference between the magnitudes of the magnetic fluxes caused by the difference between the resistances of the electric circuits from the connector 402.

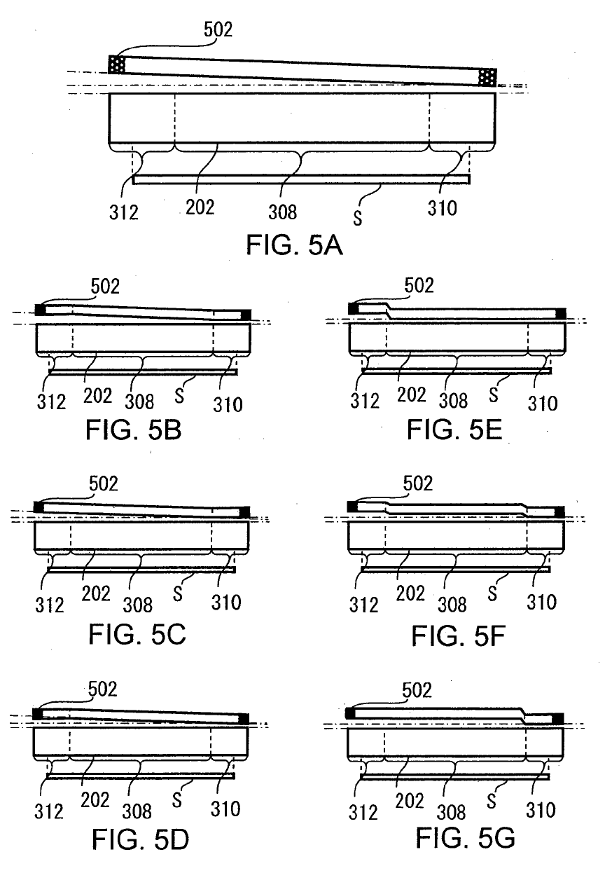

FIGS. 5A to 5G are views showing a modification of the induction coil. The induction coil 210 of the modification has a coil 502. The coil 502 is one coil to supply the magnetic flux to the whole areas including the center area 308, the front side area 310 and the rear side area 312 in the direction of the axis of rotation of the heat roller 202.

As the adjacent distance from the coil 502 to the heat roller 202 at the position facing the front side area 310 is short and the adjacent distance from the coil 502 to the heat roller 202 at the position facing the rear side area 312 is long, the magnetic flux provided to the rear side area 312 is smaller than the magnetic flux provided to the front side area 310. As the supplied magnetic flux is smaller, the heat roller 202 is unlikely to generate heat at the rear side area 312 than the front side area 310. That the heat roller 202 is unlikely to generate heat at the rear side area 312 than the front side area 310 negates the temperature difference between both the end portions of the heat roller 202 caused by the temperature difference in the space between the rear side of the image forming apparatus 100 which is at the high temperature and the front side of the image forming apparatus 100 which is at the low temperature.

As shown in FIG. 5A, the coil 502 from the position facing the front side area 310, the position facing the center area 308 and the position facing the rear side area 312 may be arranged linearly distant from the heat roller 202. As shown in FIG. 5B, while the coil 502 from the position facing the front side area 310, the position facing the center area 308 and the position facing the rear side area 312 are linearly distant from the heat roller 202, the position facing the front side area 310 and the position facing the rear side area 312 may be arranged in parallel with the heat roller 202 and the position facing the center area 308 may be inclined to the heat roller 202. As shown in FIG. 5C and FIG. 5D, while the position facing the rear side area 312 is arranged more distant from the heat roller 202 than the position facing the front side area 310 is, the position facing the front side area 310, the position facing the rear side area 312 and the position facing the center area 308 may be inclined to the heat roller 202. As shown in FIG. 5E, FIG. 5F and FIG. 5G, while the position facing the rear side area 312 is arranged more distant from the heat roller 202 than the position facing the front side area 310 is, the position facing the front side area 310, the position facing the rear side area 312 and the position facing the center area 308 may be arranged in parallel with the heat roller 202.

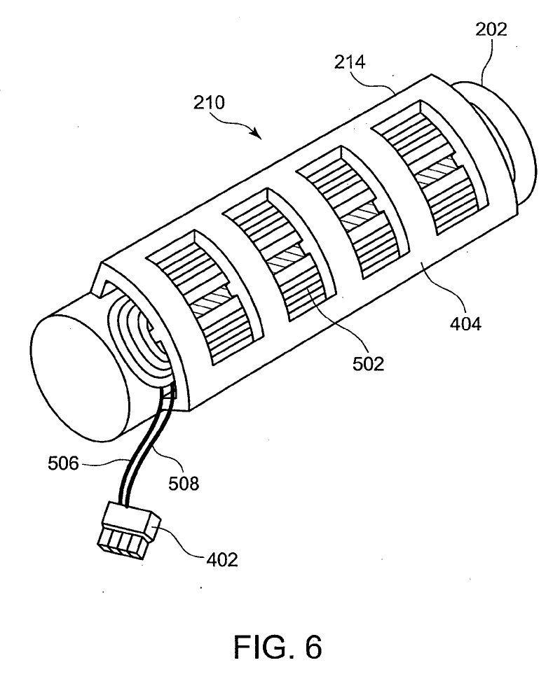

FIG. 6 is a perspective view of a modification of the heat roller 202 and the induction coil 210. The coil 502 has an electric wire 506 and an electric wire 508. Both the electric wire 506 and the electric wire 508 are held together at the rear side. The electric wire 506 and the electric wire 508 are held together in the connector 402. The connector 402 is connected to the circuit board 134 locating at the rear side of the image forming apparatus 100. As the electric wire 506, the electric wire 508 and the connector 402 are arranged in the space of the rear side, the ventilation is disturbed at the rear side so that the temperature becomes high. That the coil is more distant at the rear side from the heat roller 202 than at the front side area can correct also the temperature difference caused by the disturbance of the ventilation by the electric wire 506, the electric wire 508 and the connector 402.

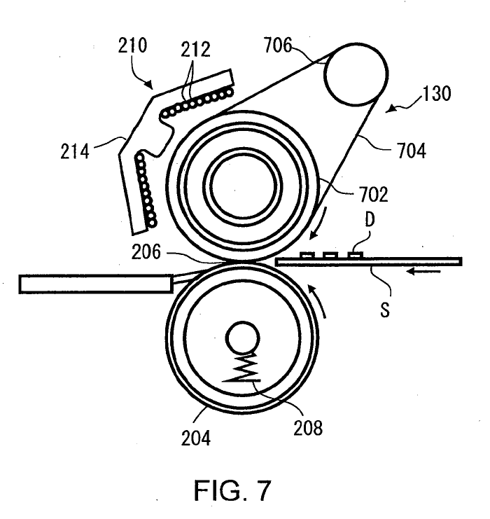

FIG. 7 is a sectional view of a first modification of the fixing device 130. The fixing device 130 is provided with a heat roller 702, a belt 704 and a satellite roller 706. The heat roller 702 makes contact with the pressure roller 204 to form the nip 206. The diameters of the heat roller 702 and the pressure roller 204 are respectively 40 mm, for example. The satellite roller 706 along with the heat roller 702 support the belt 704 so as to rotate. The satellite roller 706 is driven rotated by the belt 704 driven by the heat roller 702.

The heat roller 702 makes contact with and heats the surface of the sheet S on which the toner image D was transferred. The heat roller 702 rotates in the direction of an arrow in the drawing. The heat roller 702 is composed of a cored bar, a foamed rubber layer, a metal conductive layer, a magnetic shunt alloy layer and a mold release layer in order from the inside. For example, the formed rubber layer is 5 mm, the metal conductive layer is 40 μm, the magnetic shunt alloy layer is 200 μm, and the mold release layer is 30 μm thick, respectively. The magnetic shunt alloy layer is an alloy of iron, nickel and chromium, for example. The metal conductive layer is formed by nickel, stainless, aluminum, or a combined material of stainless and aluminum, for example.

The satellite roller 706 is formed by a ceramic with a diameter of 15 mm and a depth of 0.5 mm, for example. The satellite roller 706 may be formed by iron, stainless steel or the resin. The satellite roller 706 may be a heat pipe.

The belt 704 has a polyimide resin layer, an elastic layer and a mold release layer in order from the inside. For example, the polyimide resin layer as a base layer may be 50 μm thick, the elastic layer may be a silicone rubber of 300 μm thick, and the mold release layer may be a PFA or a PTF resin of 40 μm thick.

Or, the belt 704 may have a coat layer, a metal layer, an elastic layer and a mold release layer in order from the inside, for example, and may generate the Joule heat by the magnetic flux provided by the induction coil 210. The coat layer may be composed by dispersing the mica in the polyimide resin. The metal conductive layer is composed of nickel, stainless, aluminum or a combined material of stainless and aluminum, for example. The elastic layer may be a silicone rubber or a fluorine-contained rubber. The mold release layer may be a fluorine-contained resin.

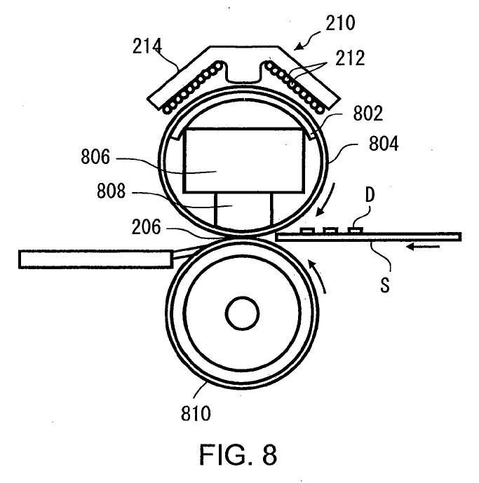

FIG. 8 is a sectional view of a second modification of the fixing device 130. The fixing device 130 is provided with a heat member 802, a belt 804, a support member 806, a pad 808 and a press roller 810. The support member 806 supports the heat member 802 and the pad 808 to the inside of the belt 804. The belt 804 pressed by the pad 808 from the inside toward the press roller 810 makes contact with the press roller 810 to form the nip 206. The diameter of the belt 804 is 50 mm, for example. The press roller 810 drives the belt 804 from the outside of the belt 804. The belt 804 is driven rotated by the press roller 810.

The heat member 802 makes contact with the inner circumference surface of the belt 804. The heat member 802 is rounded along the inner circumference surface of the belt 804. The heat member 802 faces the induction coil 210 through the belt 804. The heat member 802 may be a magnetic shunt alloy of iron, nickel and chromium, for example.

The belt 804 has a polyimide resin layer, an elastic layer and a mold release layer in order from the inside. For example, the polyimide resin layer as a base layer may be 50 μm thick, the elastic layer may be a silicone rubber of 300 μm thick, and the mold release layer may be a PFA or a PTF resin of 40 μm thick.

The belt 804 may have a coat layer, a metal layer, an elastic layer and a mold release layer in order from the inside, for example, and may generate the Joule heat by the magnetic flux provided by the induction coil 210. The coat layer may be composed by dispersing the mica in the polyimide resin. The metal conductive layer is composed of nickel, stainless, aluminum or a combined material of stainless and aluminum, for example. The elastic layer may be a silicone rubber or a fluorine-contained rubber. The mold release layer may be a fluorine-contained resin.

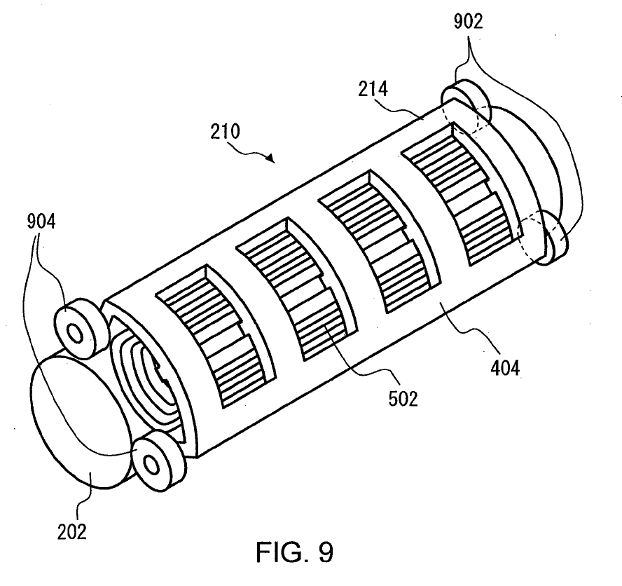

FIG. 9 is a perspective view of another modification of the heat roller 202 and the induction coil 210. The induction coil 210 is provided two rollers 902 at the front side and two rollers 904 at the rear side. The rollers 902 and the rollers 904 rotate in contact with and along the outer circumference of the heat roller 202. In order to keep the distance between the heat roller 202 and the induction coil 210, the rollers 902 and the rollers 904 support the induction coil 210 against the heat roller 202. The rollers 902 and the rollers 904 are on the same lines of the axis of rotation, respectively. As the rollers 902 are smaller in diameter than the rollers 904, the adjacent distance from the coil 502 to the heat roller 202 at the position facing the front side area 310 is kept short, and the adjacent distance at the position facing the rear side area 312 is kept long.

The rollers 902 and the rollers 904 may be on the different lines of the axis of rotation, respectively, and the diameters of the rollers 902 and the rollers 904 may be the same. Or, even though the rollers 902 and the rollers 904 are on different lines of the axis of rotation, respectively, and the diameters of the rollers 902 and the rollers 904 are different, respectively, that the adjacent distance from the coil 502 to the heat roller 202 at the position facing the front side area 310 is kept short, and the adjacent distance at the position facing the rear side area 312 is kept long may be sufficient.

What is claimed is:

1. An image forming apparatus, comprising:
an image forming portion to form an image on a sheet;
a heating rotation portion to heat the sheet to fix the image on the sheet; and
a coil to provide magnetic flux to the heating rotation portion, one end of the coil being closer to the heating rotation portion than another end of the coil in a direction of an axis of rotation of the heating rotation portion.

2. The apparatus according to claim 1, wherein:
the one end faces one end of the sheet in a width direction when the sheet having a maximum width in a specification of the image forming apparatus faces the heating rotation portion; and
the another end faces another end of the sheet in the width direction when the sheet having the maximum width in the specification of the image forming apparatus faces the heating rotation portion.

3. The apparatus according to claim 1, wherein:
a circuit board to supply a current to the coil is provided at a position closer to the another end than the one end.

4. The apparatus according to claim 1, wherein:
the another end side of the axis of rotation of the heating rotation portion intersects with a part mounting surface of a circuit board to supply a current to the coil.

5. The apparatus according to claim 1, wherein:
a maintenance door is provided at a front side so as to open up a circuit board to supply a current to the coil toward a rear side and to open up the heating rotation portion toward the front side; and
the one end of the coil at the front side is closer to the heating rotation portion than the another end of the coil at the rear side in the direction of the axis of rotation of the heating rotation portion.

6. The apparatus according to claim 1, wherein:
a maintenance door is provided at a front side so as to open up the heating rotation portion toward the front side; and
the one end of the coil at the front side is closer to the heating rotation portion than the another end in the direction of the axis of rotation of the heating rotation portion.

7. The apparatus according to claim 1, wherein:
a circuit board is provided at a rear side so as to supply a current to the coil; and
the one end of the coil is closer to the heating rotation portion than the another end at the rear side in the direction of the axis of rotation of the heating rotation portion.

8. The apparatus according to claim 1, wherein:
the coil is provided with one end side coil at the one end and another end side coil at the another end; and
the one end side coil is closer to the heating rotation portion than the another end side coil in the direction of the axis of rotation of the heating rotation portion.

9. The apparatus according to claim 1, wherein:
the coil is provided with one end side coil at the one end, another end side coil at the another end and a center coil positioned between the one end side coil and the another end side coil; and
the one end side coil is closer to the heating rotation portion than the another end side coil in the direction of the axis of rotation of the heating rotation portion.

10. The apparatus according to claim 1, wherein:
the coil is provided with one end side coil at the one end, another end side coil connected in series with the one end side coil at the another end and a center coil positioned between the one end side coil and the another end side coil; and
the one end side coil is closer to the heating rotation portion than the another end side coil in the direction of the axis of rotation of the heating rotation portion.

11. The apparatus according to claim 10, wherein:
the center coil is not connected in series with the one end side coil nor the another side coil.

12. An fixing device, comprising:
a heating rotation portion to heat a sheet to fix an image on the sheet; and
a coil to provide magnetic flux to the heating rotation portion, one end of the coil being closer to the heating rotation portion than another end of the coil in a direction of an axis of rotation of the heating rotation portion.

13. The device according to claim 12, wherein:
the one end faces one end of the sheet in a width direction when the sheet having a maximum width in a specification of an image forming apparatus faces the heating rotation portion; and
the another end faces another end of the sheet in the width direction when the sheet having the maximum width in the specification of the image forming apparatus faces the heating rotation portion.

14. The device according to claim 12, wherein:
a circuit board to supply a current to the coil is provided at a position closer to the another end than the one end.

15. The device according to claim 12, wherein:
the another end side of the axis of rotation of the heating rotation portion intersects with a part mounting surface of a circuit board to supply a current to the coil.

16. The device according to claim 12, wherein:
a maintenance door is provided at a front side so as to open up a circuit board to supply a current to the coil toward a rear side and to open up the heating rotation portion toward the front side; and
the one end of the coil at the front side is closer to the heating rotation portion than the another end of the coil at the rear side in the direction of the axis of rotation of the heating rotation portion.

17. The device according to claim 12, wherein:
a maintenance door is provided at a front side so as to open up the heating rotation portion toward the front side; and
the one end of the coil at the front side is closer to the heating rotation portion than the another end in the direction of the axis of rotation of the heating rotation portion.

18. The device according to claim 12, wherein:
a circuit board is provided at a rear side so as to supply a current to the coil; and
the one end of the coil is closer to the heating rotation portion than the another end at the rear side in the direction of the axis of rotation of the heating rotation portion.

19. The device according to claim 12, wherein;
the coil is provided with one end side coil at the one end and another end side coil at the another end; and
the one end side coil is closer to the heating rotation portion than the another end side coil in the direction of the axis of rotation of the heating rotation portion.

20. The device according to claim 12, wherein:
the coil is provided with one end side coil at the one end, another end side coil at the another end and a center coil positioned between the one end side coil and the another end side coil; and
the one end side coil is closer to the heating rotation portion than the another end side coil in the direction of the axis of rotation of the heating rotation portion.
